(19) United States
(12) Patent Application Publication
(10) Pub. No.: US 2005/0181963 A1
(43) Pub. Date: Aug. 18, 2005

(54) Stain treating composition

(76) Inventor: Luca Spadoni, Mirano (IT)

Correspondence Address: NORRIS, MCLAUGHLIN & MARCUS, 875 THIRD AVE, 18TH FLOOR, NEW YORK, NY, 10022, US

(21) Appl. No.: 10/490,238

(22) PCT Filed: Jul. 18, 2003
(86) PCT No.: PCT/GB03/03133

(30) Foreign Application Priority Data
Jul. 20, 2002 (GB) 0216950.6
Apr. 10, 2003 (GB) 0308231.0

(51) Int. Cl. C11D 17/00

(52) U.S. Cl. 510/295

(57) ABSTRACT

A multi-compartment liquid dispenser comprising first and second liquid containing compartments, wherein present in at least one compartment is a first component that generates a gas upon the mixing of the liquid contents of the first and second compartments and a second component that foams when gas is generated by the first component and the foam subsequently quickly breaks.

This invention relates to an improved process for the removal of stains from surfaces, preferably from fabric, and to compositions used in such processes.

EP 0745 665, WO 0100765 and WO 0012672 describe products that contain two liquids that are intended for cleaning. Upon mixing the two components produce an effervescent effect that alongside the surfactants present produce a foam.

WO 9731095 describes an apparatus for claiming surfaces that contains two liquids that are mixed upon delivery to the surface. The first liquid contains a hydrohalite bleach. The second liquid has a chelating agent or a builder. The pH on mixture of the two liquids is about 11.

We have found that although an effervescent effect may be desirable and add to the cleaning performance a persistent foam may have several non-beneficial effects. Firstly it may be difficult to rinse away and secondly the foam may obscure the stain removing performance from the user.

We have found that by providing in either or both of the two separate compositions [mixed during, before or after (preferably during or before) application] with a quick breaking foam forming component the above problems are overcome.

We present as a feature of the invention a multi compartment liquid dispenser comprising first (a) and second (b) liquid containing compartments, wherein present in at least one compartment is a first component that generates a gas upon the mixing of the liquid contents of the first and second compartments and a second component that foams when gas is generated by the first component and subsequently the foam quickly breaks.

Preferably the product is used for stain removal at a surface, ideally a fabric surface. Preferably the surface is a fabric surface, such as an item of clothing, linen or carpet. Ideally the fabric surface is a coloured fabric.

We present as a further feature of the invention a process for stain removal at a surface comprising applying to that surface a mixture of at least two aqueous compositions, wherein present in at least one of the compositions is a first component that generates a gas upon the mixing of the liquid content of the first and second compartments and a second component that foams when gas is generated by the first component and then subsequently the foam quickly breaks.

Quick Breaking Foam

Preferably the foam breaks within 5 minutes of formation after mixing, ideally less than 5, 4, 3, 2, or 1 minute. Preferably the foam does not break for at least 10 seconds, 20 seconds, 30 seconds, 1, 2 or 3 minutes. By the use of the term “break or breaks” we mean that at least 50% of the volume of foam generated by the mixing of component (a) and (b) has disappeared without any form of physical or chemical intervention.

Preferred surfactant to achieve this effect are those selected from below, and include mixtures thereof, preferably they are hydophilic, i.e. their hydrophilic/lipohilic balance HLB is greater than 10.

Anionic Surfactant

Preferred anionic surfactants capable of producing a breaking foam are ethoxylated alkyl sulfates of the formula:
RO(C₂H₄O)ₙSO₃⁻M⁺
wherein R is a C₈-C₂₀ alkyl group, preferably C₁₀-C₁₈ such as a C₁₂-C₁₆, n is at least 4, for example from 4 to 20, preferably 4 to 9, especially 4 to 6, and M is a salt-forming cation such as lithium, sodium, potassium, ammonium, alkylammonium or alkanolammonium.
   Nonionic Surfactants

Preferred nonionic surfactants capable of producing a breaking foam are fatty alcohol ethoxylates, especially those of formula:
R(C₂H₄O)ₙOH
wherein R is a straight or branched C₈-C₁₆ alkyl group, preferably a C₉-C₁₅, for example C₁₀-C₁₄, alkyl group and n is at least 4, for example from 4 to 16, preferably 4 to 12, more preferably 4 to 10.

Preferably the HLB value is greater than 9, ideally greater than 10.

Examples of fatty alcohol ethoxylates are those made from alcohols of 12 to 15 carbon atoms and which contain about 7 moles of ethylene oxide. Such materials are commercially marketed under the trademarks Neodol 25-7 and Neodol 23-6.5 by Shell Chemical Company.

An additional or alternative group of preferred nonionic surfactants are the polyoxyalkylated non-ionics of formula:
R¹O[CH₂CH(R³)O]_{X}[CH₂]ₖCH(OH)[CH₂]ⱼOR²
wherein R¹ and R² represent linear or branched chain, saturated or unsaturated, aliphatic or aromatic hydrocarbon groups with 1-30 carbon atoms (presently 1 to 10) or one of R¹ and R² may be a hydrogen, R³ represents a hydrogen atom or a methyl group, x is a value between 2 and 30 and, k and j are values between 1 and 12, preferably between 1 and 5. R¹ and R² are preferably linear or branched chain, saturated or unsaturated, aliphatic or aromatic hydrocarbon groups with 6-22 carbon atoms, where group with 8 to 18 carbon atoms are particularly preferred. Particularly preferred values for x are comprised between 2 and 20, preferably between 4 and 15.

When x=2 or 3, the group R³ could be chosen to build ethylene oxide (R³═H) or propylene oxide (R³=methyl) units which can be used in every single order for instance (PO) (EO)(EO), (EO)(PO)(EO), (EO)(EO)(PO), (EO)(EO) (EO), (PO) (EO) (PO), (PO) (PO) (EO) and (PO)(PO)(PO). The value 2 or 3 for x is only an example and bigger values can be chosen whereby a higher number of variations of (EO) or (PO) units would arise.

Alternatively when x=2 or 3, the group R³ could be chosen to build ethylene oxide (R³=H) or propylene oxide (R³=methyl) units which can be used in every single order for instance (EO)(EO)(EO), (PO)(PO)(PO), (PO)(EO)(PO), (EO)(PO)(EO), (PO)(PO) and (EO)(EO). The value 2 or 3 for x is only an example and bigger values can be chosen whereby a higher number of variations of (EO) or (PO) units would arise.

Particularly preferred polyoxyalkylated alcohols of the above formula are those where k=1 and j=1 originating molecules of simplified formula:
R¹O[CH₂CH(R³)O]_{X}CH₂CH(OH)CH₂OR².

A suitable example is Biodac 232, available from Condea or Berol 185 from Akzo Nobel.

Gas Generation

In one preferred embodiment of the invention an effervescent effect is achieved upon mixing (a) and (b). The effervescent component typically comprises two agents to react to generate gas. Preferably one agent comprises an effervescent base, preferably present at a level of from about 1% to about 10%, more preferably from about 2% to about 5% by weight of the compositions of the present invention. Preferably the other effervescent agent is an acid.

Suitable effervescent bases are selected from carbonates, bicarbonates, sesquicarbonates and mixtures thereof. Preferably, the base is selected from the group consisting of sodium carbonate, potassium carbonate, lithium carbonate, magnesium carbonate, calcium carbonate, ammonium carbonate, mono-, di-, tri- or tetra-alkyl or aryl, substituted or unsubstituted, ammonium carbonate, sodium bicarbonate, potassium bicarbonate, lithium bicarbonate, magnesium bicarbonate, calcium bicarbonate, ammonium bicarbonate, mono-, di-, tri- or tetra-alkyl or aryl, substituted or unsubstituted, ammonium bicarbonate and mixtures thereof.

The most preferred bases are selected from the group consisting of sodium bicarbonate, monoethanol-ammonium bicarbonate and mixtures thereof.

In another preferred embodiment, one effervescent agent preferably comprises a peroxide reducing enzyme that is preferably held within component (b), such as peroxidase, laccase, dioxygenase and/or catalase enzyme, preferably catalase enzyme, preferably present at a level of from about 0.001% to about 10%, more preferably, from about 0.01% to about 5%, even more preferably from about 0.1% to about 1%, most preferably from about 0.1% to about 0.3% by weight of the compositions of the present invention. The other effervescent agent is preferably, hydrogen peroxide. Catalase enzyme is commercially available from Biozyme Laboratories under the trade name Cat-lA, which is a bovine liver derived catalyse enzyme; from Genencor International under the trade name Oxy-Gone 400, which is a bacterial derived catalyse enzyme; and from Novo Nordisk under the trade name Terminox Ultra 50L.

According to the invention there is provided a process for stain removal at a surface, comprising applying to that surface a mixture of at least two aqueous compositions:
(a) an aqueous composition comprising having a pH of greater than 0 but less than 7 [hereinafter component (a)] and
(b) an aqueous composition comprising an effervescent base and wherein component (a), (b) or both (a) and (b) contains a component that foams and then quickly breaks upon the mixing of (a) and (b).
   Preferably component (a) and/or component (b) additionally comprise at least one surfactant or water-soluble polymer. Preferably component (a) contains a source of active oxygen. Preferably component (b) contains at least one enzyme.
   pH
   The pH of component (a) is preferably less than 7, ideally less than 6.5, 5.0, 4.5, 4.0, 3.5 or 3.0. Ideally the pH is at least 1.0, 1.5, 2.0 or 2.5.
   The pH of component (b) is preferably greater than 7, ideally greater than 7.5, 8.0, 8.5, 9.0, 9.5 or 10.0. Ideally the pH is less than 13.0, 12.5, 12.0 or 11.5. The pH of either (a) or (b) can be adjusted by the addition of a suitable acid or base.
   Alkalising Agent

Preferably component (b) contains an alkalising agent. An alkalising agent is a compound or mixture of compounds that can increase the pH of the resultant mixture of (a) and (b) to a pH of >8.0, ideally >8.5, >9.0, >9.5 or >10.0. Preferably the alkalising agent produces a pH of <11.0 or <10.5. The alkalising agent ideally comprises a base. Suitable bases are selected from carbonates, bicarbonates, sequicarbonates, hydroxides, and silicates.

Therefore, the pH of component (b) is preferably higher than the pH of component (a).

Preferably component (b) contains an alkalising agent. An alkalising agent is a compound or mixture of compounds that can increase the pH of the resultant mixture of (a) and (b) to a pH of >8.0, ideally >8.5, >9.0, >9.5 or >10.0. Preferably the alkalising agent produces a pH of <11.0 or <10.5. The alkalising agent ideally comprises a base. Suitable bases are selected from hydroxides, carbonates, bicarbonates, sequicarbonates, hydroxides, and silicates.

Therefore, the pH of component (b) is preferably higher than the pH of component (a).

Ideally, an alkaline buffering means is also present. An alkaline buffering means at a level of from 0.1% to 10% by weight of component (b). Preferably, component (b) herein comprise from 0.2% to 8% by weight of the total composition of a pH buffering means or a mixture thereof, preferably from 0.3% to 5%, more preferably from 0.3% to 3% and most preferably from 0.3% to 2%.

By “alkaline buffering means”, it is meant herein any compound which when mixed with component (a) makes the resulting solution able to resist an increase in hydrogen ion concentration.

Preferred alkaline buffering means for use herein comprise an acid having its pK (if only one) or at least one of its pKs in the range from 7.5 to 12.5, preferably from 8 to 10, and its conjugated base.

pK is defined according to the following equation:
pK=−logK
where K is the Dissocation Constant of the weak acid in water and corresponds to the following equation:
[A][H]/[HA]=K
where HA is the acid and A is the conjugated base.

Preferably the alkaline buffering means herein consists of the weak acid and its conjugate base at a weight ratio of the weak acid to its conjugate base of preferably 0.1:1 to 10:1, more preferably 0.2:1 to 5:1. Highly preferred ratio of the weak acid to its conjugate base is 1 since this is the best combination to achieve optimum buffering capacity.

Preferably a given pH buffering means herein will be used to buffer compositions having a pH between pH=pK−1 and pH=pK+1 of each of its pK.

Suitable pH buffers are formed from acid addition salts of bases that have a pKb within 1 unit of the pH of component (b). Suitable buffering systems are selected from: carbonate/bicarbonate, citric acid/citrates, borate/boric acid or phosphates/phosphoric acid or any other buffer systems described in literature.

Preferably component (a) does not have a pH buffer present. Ideally only component (b) has a pH buffer.

Sources of Active Oxygen

The use of oxygen bleaches with or without enzymes in compositions for stain removal has been known for a long time and many such compositions are available.

However a common difficulty in formulating such a composition is to ensure that the bleach remains stable during storage but is sufficiently active on use. This is particularly difficult to achieve in liquid compositions.

One solution has been to formulate liquid peroxygen bleaches at pHs between about 3 and 7 to produce a stable composition, but such compositions do not provide sufficient bleaching power to be useful for many household situations. Attempts have therefore also been made to formulate liquid peroxygen bleach compositions at pHs above this range to improve their performance. However these generally require expensive stabilising compounds to prevent loss of activity after manufacture.

Enzymes are a common component of stain treating compositions. Enzymes lose their cleaning performance in presence of a strong oxidant, such as hydrogen peroxide at alkaline pH. Surprisingly, we have found that by the inclusion of a surfactant or a water-soluble polymer in either or both of the separate compositions, (preferably present in at least the enzyme composition or both compositions) excellent cleaning performance is achieved. Whilst not wishing to be bound by theory, it is believed that the activity of the enzyme is maintained for a longer period after the peroxide composition is mixed with the enzyme composition by the protective effects of surfactant micelles formed in the mixture.

An essential ingredient is a source of active oxygen. A preferred source according to the present invention is hydrogen peroxide or sources thereof. As used herein a hydrogen peroxide source refers to any water-soluble source of hydrogen peroxide. Suitable water-soluble sources of hydrogen peroxide for use herein include percarbonates, organic or inorganic peroxides and perborates.

Hydrogen peroxide or sources thereof provide from 0.1% to 15%, preferably from 0.5% to 10%, most preferably from 1% to 5% by weight of the total composition of active oxygen in said composition.

As used herein active oxygen concentration refers to the percentage concentration of elemental oxygen, with an oxidation number zero, that being reduced to water would be stoichiometrically equivalent to a given percentage concentration of a given peroxide compound, when the peroxide functionality of the peroxide compound is completely reduced to oxides. The active oxygen sources according to the present invention increase the ability of the compositions to remove oxidisable stains, to destroy malodorous molecules and to kill germs.

The concentration of available oxygen can be determined by methods known in the art, such as the iodimetric method, the permanganometric method and the cerimetric method. Said methods and the criteria for the choice of the appropriate method are described for example in “Hydrogen Peroxide”, W. C. Schumo, C. N. Satterfield and R. L. Wentworth, Reinhold Publishing Corporation, New York, 1955 and “Organic Peroxides”, Daniel Swern, Editor Wiley Int. Science, 1970.

Suitable organic and inorganic peroxides for use in the compositions according to the present invention include diacyl and dialkyl peroxides such as dibenzoyl peroxide, dilauroyl peroxide, dicumyl peroxide, persulphuric acid and mixtures thereof. The compositions according to the present invention comprise from 0% to 15%, preferably from 0.005% to 10%, by weight of the total composition of said organic or inorganic peroxides.

Suitable preformed peroxyacids for use in the compositions according to the present invention include diperoxydodecandioic acid DPDA, magnesium perphthalatic acid, perlauric acid, perbenzoic acid, diperoxyazelaic acid and mixtures thereof. The compositions according to the present invention comprise from 0% to 15%, preferably from 0.005% to 10%, by weight of the total composition of said preformed peroxyacids.

Optionally, the compositions may additionally comprise from 0% to 30%, preferably from 2% to 20% of peracid precursors, i.e. compounds that upon reaction with hydrogen peroxide product peroxyacids. Examples of peracid precursors suitable for use in the present invention can be found among the classes of anhydrides, amides, imides and esters such as acetyl triethyl citrate (ATC) described for instance in EP 91 87 0207, tetra acetyl ethylene diamine (TAED), succinic or maleic anhydrides.

Additional Surfactant

Preferably, the surfactant is found at levels of 0.1 to 25% wt, ideally from 1 to 10% w and may be found in (a), (b) or both (a) and (b), preferably at least in (b).

Ideally sufficient total surfactant is present in each composition (a) or (b) or (a) and (b), such that upon mixture of (a) and (b) the critical micelle concentration (CMC) is reached, i.e. the level above which the formation of micelles occurs [typically measured by a change in physical properties, i.e. turbidity or conductivity].

Preferably non-ionic surfactants are used. Examples of non-ionic surfactants are fatty acid alkoxylates, such as fatty acid ethoxylates, especially those of formula:
R(C₂H₄O)ₙOH
wherein R is a straight or branched C₈-C₁₆ alkyl group, preferably a C₉-C₁₅, for example C₁₀-C₁₄, alkyl group and n is at least 1, for example from 1 to 16, preferably 2 to 12, more preferably 3 to 10.

The alkoxylated fatty alcohol non-ionic surfactant will frequently have a hydrophilic-lipophilic balance (HLB) which ranges from 3 to 17, more preferably from 6 to 15, most preferably from 7 to 13.

Examples of fatty alcohol ethoxylates are those made from alcohols of 12 to 15 carbon atoms and which contain about 7 moles of ethylene oxide. Such materials are commercially marketed under the trademarks Neodol 25-7 and Neodol 23-6.5 by Shell Chemical Company. Other useful Neodols include Neodol 1-5, an ethoxylated fatty alcohol averaging 11 carbon atoms in its alkyl chain with about 5 moles of ethylene oxide; Neodol 23-9, an ethoxylated primary C₁₂-C₁₃ alcohol having about 9 moles of ethylene oxide; and Neodol 91-10, an ethoxylated C₉-C₁₁ primary alcohol having about 10 moles of ethylene oxide.

Alcohol ethoxylates of this type have also been marketed by Shell Chemical Company under the Dobanol trademark. Dobanol 91-5 is an ethoxylated C₉-C₁₁ fatty alcohol with an average of 5 moles ethylene oxide and Dobanol 25-7 is an ethoxylated C₁₂-C₁₅ fatty alcohol with an average of 7 moles of ethylene oxide per mole of fatty alcohol.

Other examples of suitable ethoxylated alcohol non-ionic surfactants include Tergitol 15-S-7 and Tergitol 15-S-9, both of which are linear secondary alcohol ethoxylates available from Union Carbide Corporation. Tergitol 15-S-7 is a mixed ethoxylated product of a C₁₁-C₁₅ linear secondary alkanol with 7 moles of ethylene oxide and Tergitol 15-S-9 is the same but with 9 moles of ethylene oxide.

Other suitable alcohol ethoxylated non-ionic surfactants are Neodol 45-11, which is a similar ethylene oxide condensation products of a fatty alcohol having 14-15 carbon atoms and the number of ethylene oxide groups per mole being about 11. Such products are also available from Shell Chemical Company.

Further non-ionic surfactants are, for example, C₁₀-C₁₈ alkyl polyglycosides, such as C₁₂-C₁₆ alkyl polyglycosides, especially the polyglucosides. These are especially useful when high foaming compositions are desired. Further surfactants are polyhydroxy fatty acid amides, such as C₁₀-C₁₈ N-(3-methoxypropyl)glycamides and ethylene oxide-propylene oxide block polymers of the Pluronic type.

The surfactant can also be an anionic surfactant. Such anionic surface active agents are frequently provided in a salt form, such as alkali metal salts, ammonium salts, amine salts, aminoalcohol salts or magnesium salts. Contemplated as useful are one or more sulfate or sulfonate compounds including: alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Particularly preferred are alkyl sulphate anionic surfactants. Most preferred are the non-ethoxylated C₁₂₋₁₅ primary and secondary alkyl sulphates, especially sodium lauryl sulfate.

In yet another aspect of the present invention, an effervescent system comprising an effervescent agent-containing component, preferably a base, is within component (b), such that when mixed with the acidic pH of component (a) generates effervescence.

Enzyme

Enzymes are a common component of stain treating compositions. Enzymes lose their cleaning performance in presence of a strong oxidant, such as hydrogen peroxide at alkaline pH. Surprisingly, we have found that by the inclusion of a surfactant or a water-soluble polymer in either or both of the separate compositions, (preferably present in at least the enzyme composition or both compositions) excellent cleaning performance is achieved. Whilst not wishing to be bound by theory, it is believed that the activity of the enzyme is maintained for a longer period after the peroxide composition is mixed with the enzyme composition by the protective effects of surfactant micelles formed in the mixture.

Where present said enzymes are preferably selected from cellulases, hemicellulases, peroxidases, proteases, gluco-amylases, amylases, xylanases, lipases, phospholipases, esterases, cutinases, pectinases, keratanases, reductases, oxidases, phenoloxidases, lipoxygenases, ligninases, pullulanases, tannases, pentosanases, malanases, beta-glucanases, arabinosidases, hyaluronidase, chondroitinase, laccase or mixtures thereof.

Preferred enzymes include protease, amylase, lipase, peroxidases, cutinase and/or cellulase.

The cellulases usable in the present invention include both bacterial or fungal cellulase. Preferably, they will have a pH optimum of between 5 and 12 and an activity above 50 CEVU (Cellulose Viscosity Unit). Suitable cellulases are disclosed in U.S. Pat. No. 4,435,307, JP-A-61078384 and WO-A-96/02653 which disclose fungal cellulases produced respectively from Humicola insolens, Trichoderma, Thielavia and Sporotrichum. EP-A-739 982 describes cellulases isolated from novel Bacillus species. Suitable cellulases are also disclosed in GB-A-2.075.028; GB-A-2.095.275; DE-OS-2.247.832 and WO-A-95/26398.

If present, cellulases are normally incorporated in the detergent composition at levels from 0.0001% to 2% of active enzyme by weight of the detergent composition.

Peroxidase enzymes are used in combination with oxygen sources, e.g. percarbonate, perborate, persulfate, hydrogen peroxide, etc. They are used for “solution bleaching”, i.e. to prevent transfer of dyes or pigments removed from substrates during wash operations to other substrates in the wash solution. Peroxidase enzymes are known in the art, and include, for example, horseradish peroxidase, ligninase and haloperoxidase such as chloro- and bromo-peroxidase. Peroxidase-containing detergent compositions are disclosed, for example, in WO-A-89/099813, WO-A-89/09813 and in EP-A-540784. Also suitable is the laccase enzyme.

If present, peroxidases are normally incorporated in the detergent composition at levels from 0.0001% to 2% of active enzyme by weight of the detergent composition.

Other preferred enzymes that can be included in the detergent compositions of the present invention include lipases. Suitable lipase enzymes for detergent usage include those produced by microorganisms of the Pseudomonas group, such as Pseudomonas stutzeri ATCC 19.154, as disclosed in GB-A-1,372,034. Suitable lipases include those which show a positive immunological cross-reaction with the antibody of the lipase, produced by the microorganism Pseudomonas fluorescent IAM 1057. This lipase is available from Amano Pharmaceutical Co. Ltd., Nagoya, Japan, under the trade name Lipase P “Amano,” hereinafter referred to as “Amano-P”. Other suitable commercial lipases include Amano-CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., The Netherlands, and lipases ex Pseudomonas gladioli. Especially suitable lipases are lipases such as Ml Lipase™ and Lipomax™ (Gist-Brocades) and Lipolase™ and Lipolase Ultra™ (Novo) which have found to be very effective when used in combination with the compositions of the present invention. Also suitables are the lipolytic enzymes described in EP-A-258068, WO-A-92/05249, WO-A-95/22615, WO-A-94/03578, WO-A-95/35381 and WO-A-96/00292.

Also suitable are cutinases [EC 3.1.1.50] which can be considered as a special kind of lipase, namely lipases which do not require interfacial activation. Addition of cutinases to detergent compositions have been described in e.g. WO-A-88/09367; WO-A-90/09446, WO-A-94/14963 and WO-A-94/14964.

The lipases and/or cutinases are normally incorporated in either or both composition at a level from 0.0001% to 2% of active enzyme by weight of the composition.

Suitable proteases are the subtilisins which are obtained from particular strains of B. subtilis and B. licheniformis (subtilisin BPN and BPN′). One suitable protease is obtained from a strain of Bacillus, having maximum activity throughout the pH range of 8-12, developed and sold as ESPERASE™ by Novo Industries A/S of Denmark, hereinafter “Novo”. The preparation of this enzyme and analogous enzymes is described in GB-A-1,243,784 to Novo. Other suitable proteases include ALCALASE™, DURAZYM™ and SAVINASE™ from Novo and MAXATASE™, MAXACAL™, PROPERASE™ and MAXAPEM™ (protein engineered Maxacal) from Gist-Brocades. Proteolytic enzymes also encompass modified bacterial serine proteases, such as those described in EP-A-292623 (particularly pages 17, 24 and 98), and which is called herein “Protease B”, and in EP-A-199,404, which refers to a modified bacterial serine protealytic enzyme which is called “Protease A” herein. Suitable is what is called herein “Protease C”, which is a variant of an alkaline serine protease from Bacillus in which lysine replaced arginine at position 27, tyrosine replaced valine at position 104, serine replaced asparagine at position 123, and alanine replaced threonine at position 274. Protease C is described in WO-A-91/06637. Genetically modified variants, particularly of Protease C, are also included herein.

High pH protease are preferred, such as from Bacillus sp. NCIMB 40338 described in WO-A-93/18140. Enzymatic detergents comprising protease, one or more other enzymes, and a reversible protease inhibitor are described in WO-A-92/03529. When desired, a protease having decreased adsorption and increased hydrolysis is available as described in WO-A-95/07791. A recombinant trypsin-like protease for detergents suitable herein is described in WO-A-94/25583. Other suitable proteases are described in EP-A-516,200.

The proteolytic enzymes are incorporated in either or both compositions at a level of from 0.0001% to 2%, preferably from 0.001% to 0.2%, more preferably from 0.005% to 0.1% pure enzyme by weight of the composition.

Amylases (alpha and/or beta) can be included for removal of carbohydrate-based stains. WO-A-94/02597 describes cleaning compositions which incorporate mutant amylases. See also WO-A-95/10603. Other amylases known for use in cleaning compositions include both alpha- and beta-amylases. alpha-Amylases are known in the art and include those disclosed in U.S. Pat. No. 5,003,257; EP-A-252,666; WO-A-/91/00353; FR-A-2,676,456; EP-A-285,123; EP-A-525,610; EP-A-368,341; and GB-A-1,296,839. Other suitable amylases are stability-enhanced amylases described in WO-A-94/18314 and WO-A-96/05295 and amylase variants having additional modification in the immediate parent available from Novo Nordisk A/S, disclosed in WO-A-95/10603. Also suitable are amylases described in EP-A-277,216, WO-A-95/26397 and WO-A-96/23873.

Examples of commercial alpha-amylases products are Purafect Ox Am™ from Genencor and Termamyl™, Ban™, Fungamyl™ and Duramyl™, Natalase™ all available from Novo Nordisk A/S Denmark. WO-A-95/26397 describes other suitable amylases: alpha-amylases characterised by having a specific activity at least 25% higher than the specific activity of Termamyl™ at a temperature range of 25 DEG C. to 55 DEG C. and at a pH value in the range of 8 to 10, measured by the Phadebas™ alpha-amylase activity assay. Suitable are variants of the above enzymes, described in WO-A-96/23873. Other amylolytic enzymes with improved properties with respect to the activity level and the combination of thermostability and a higher activity level are described in WO-A-95/35382.

Preferred amylase enzymes include those described in WO-A-95/26397 and in co-pending application by Novo Nordisk PCT/DK96/00056.

The amylolytic enzymes are incorporated in either or both compositions at a level of from 0.0001% to 2%, preferably from 0.00018% to 0.06%, more preferably from 0.00024% to 0.048% pure enzyme by weight of the composition.

Polymer

Suitable polymers are those that are water-soluble and include polycarboxylate polymer (such as those that can be purchased by Rohm and Haas under the Acusol 445N name) and polycarboxylic acid copolymers (such as can be purchased under the Sokalan CP9 name by BASF).

Compositions suitable for carrying out the invention may be provided as separate components suitable for mixing by the consumer. Where the compositions are suitable for mixing they may be mixed either directly at the surface or remote from the surface before application.

Component (a) preferably comprises hydrogen peroxide or peracetic acid.

In accordance with the invention the two components (a) and (b) may be mixed in any suitable proportions, depending upon their initial concentrations, suitably such that the finally applied mixture comprises 0.01-30% w/w of hydrogen peroxide or an organic peracid. Preferably, the ratio of component (a) to component (b) is from 10:1 to 1:10, most preferably from 2:1 to 1:2, ideally 0.8:1 to 1:0.8.

It is preferred that the two components (a) and (b) are mixed no more than 10 minutes before application to the surface requiring stain removal.

It is most preferred that the two components (a) and (b) are mixed at the surface requiring stain removal, so that the improved stain removal effect may occur immediately.

In this aspect component (a) may be applied to the surface followed by component (b) or vice versa. Alternatively (and preferably) components (a) and (b) are applied to the surface substantially simultaneously within 30 seconds.

According to a preferred embodiment of the presentation invention, the concentration of hydrogen peroxide or organic peracid in the composition immediately after mixing is from 0.01 to 10% w/w. This would mean for example in a 1:1 mix of component (a) and (b) that component (a) prior to the mixing would contain from 0.02 to 20% w/w of hydrogen peroxide or an organic peracid.

Where component (a) comprises hydrogen peroxide it is most preferred that the concentration of hydrogen peroxide in the mixture immediately after mixing should be from 1.5 to 5% w/w. For example, if a 1:1 mixture of components (a) and (b) is to be mixed, then component (a) should comprise from 3 to 10% w/w hydrogen peroxide.

The concentration of the enzyme in component (b) will be less than 1% wt.

The process of the present invention alleviates the need to use further stabilising components for the hydrogen peroxide/organic peracid when preparing commercial products. In addition enzyme activity is maintained for longer periods upon storage and in use.

The components suitable for use in the process according to the invention may further include any other auxiliary ingredients—known to the art. Ideally such auxiliary ingredients are selected from; fragrance, dye, sequesterant, chelating agent, germicide, preservative, corrosion inhibitor, antioxidant or a mixture of any thereof.

The above auxiliary ingredients may be included at concentrations of from 0.01% w/w to 10% w/w. These auxiliary ingredients may be included in either component (a), or component (b) or both if appropriate.

Compositions suitable for use in the process according to the present invention may be stored in any appropriate containers known to the art. For example, the two components may be stored in two-compartment packs suitable for sequential or simultaneous dispensing.

Preferably both components (a) and (b) are liquids, most preferably they may be stored in a two-compartment dispenser, one compartment containing each component and the dispenser being adapted to dispense each component on to a surface, either sequentially or, preferably, simultaneously.

Containers

Containers that have at least two compartments are disclosed in the prior art. An example of a two chamber squeezy dispenser is disclosed in US 5765725. An example of a gravity driven two chamber dispensing system is disclosed in WO 0185595. An example of a spray dispenser having two liquid compartments is disclosed in EP 0479451.

### EXAMPLES

The invention will now be illustrated by the following Examples.

### Example 1

| | % wt |
|---|---|
| First chamber | |
| Water | 71.8 |
| Hydrogen peroxide 50% | 14 |
| Citric Acid 50% | 10 |
| Chelating Agent | 1 |
| Sodium hydroxide 50% | 3.2 |
| Total | 100.0 |
| Second chamber | |
| Water | 73.58 |
| Dowicil 75 | 0.050 |
| Sodium borate decahydrate | 0.514 |
| Trisodium citrate | 1.3 |
| Copolymer dispersant(25%) | 0.200 |
| Enzyme | 0.44 |
| Sodium bicarbonate | 4 |
| Propylene glycol | 4 |
| Berol 185 | 15 |
| Acusol | 0.7 |
| Perfume | 0.21 |
| Total | 100 |

### Example 2

| | % wt |
|---|---|
| First chamber | |
| Water | 71.8 |
| Hydrogen peroxide 50% tech | 14 |
| Citric Acid 50% | 10 |
| Pentasodium DTPA 40% | 1 |
| Sodium hydroxide 50% | 3.2 |
| Total | 100 |
| Second chamber | |
| Water | 73.586 |
| Dowicil 75 | 0.05 |
| Sodium borate decahydrate | 0.514 |
| Trisodium citrate | 1.3 |
| Dispersant Polymer (25%) | 0.2 |
| Enzyme | 0.44 |
| Sodium bicarbonate | 4 |
| Propylene glycol | 4 |
| Berol 185 | 15 |
| Acusol (45%) | 0.7 |
| Perfume | 0.21 |
| Total | 100 |

1. A multi-compartment liquid dispenser comprising first and second liquid containing compartments, wherein present in at least one compartment is a first component that generates a gas upon the mixing of the liquid contents of the first and second compartments and a second component that foams when gas is generated by the first component and the foam subsequently quickly breaks.

2. A dispenser according to claim 1 wherein hydrogen peroxide or an acid is present in the first compartment.

3. A dispenser according to claim 2 wherein an effervescent agent is present in the second compartment.

4. A dispenser according to claim 3 wherein the effervescent agent is an effervescent base or a peroxide reducing enzyme.

5. A dispenser as according to claim 1 wherein the pH of one of said first or second liquid containing compartments is higher than the pH of the other of said first or second liquid containing compartments.

6. A dispenser according to claim 5 wherein the first compartment does not contain a pH buffer.

7. A dispenser according to claim 5 wherein the second compartment does contain a pH buffer.

8. A dispenser according to claim 4 wherein the effervescent base is a carbonate or a bicarbonate.

9. A dispenser according to claim 1 wherein the second component contains a nonionic surfactant having an HLB of greater than 10.

10. A process for stain removal at a surface comprising
applying to that surface a mixture of at least two aqueous compositions, wherein present in at least one of the compositions is a first component that generates a gas upon the mixing of the liquid content of the first and second compartments and a second component that foams when gas is generated by the first component wherein the foam subsequently quickly breaks.
